(19) United States
(12) Patent Application Publication
(10) Pub. No.: US 2011/0161239 A1
(43) Pub. Date: Jun. 30, 2011

(54) PROVIDING EMERGENCY PLANS FOR A FACILITY

(75) Inventors: BRYAN MUEHLMEIER, OVERLAND PARK, KS (US); JOSEPH JENNINGS, KANSAS CITY, MO (US); AARON SLOUP, PRAIRIE VILLAGE, KS (US)

(73) Assignee: CERNER INNOVATION, INC., Overland Park, KS (US)

(21) Appl. No.: 12/650,830

(22) Filed: Dec. 31, 2009

(51) Int. Cl. G06Q 10/00; G08B 17/12; G01W 1/00; G08B 23/00; G06F 3/048

(52) U.S. Cl. 705/324; 340/577; 340/601; 340/573.1; 715/764

(57) ABSTRACT

Systems, methods, and computer-readable media for generating emergency plans for a facility are provided. In embodiments, an emergency plan is generated for a designated area of a facility. An alert is received that includes an alert type. The alert type is identified and a plurality of emergency plans associated with the alert type are provided. The plurality of emergency plans includes a primary emergency plan and an alternate emergency plan. A determination is made whether any factors that affect the primary emergency plan are present. If no factors that affect the primary emergency plan are present, the primary emergency plan is displayed to a user. If factors that affect the primary emergency plan are present, the alternate emergency plan is displayed to the user.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

One embodiment of the present invention is directed to a set of computer-useable instructions providing a method for generating emergency plans for a facility. The method includes receiving an alert that includes an alert type. The alert type is identified along with a plurality of emergency plans, which are associated with the alert type, for a designated area of the facility. The plurality of emergency plans includes a primary emergency plan and an alternate emergency plan. A determination is made whether at least one factor that affects the primary emergency plan is present. Based upon a determination that at least one factor that affects the primary emergency plan is not present, displaying the primary emergency plan to a user. Based upon a determination that at least one factor that affects the primary emergency plan is present, displaying the alternate emergency plan to the user.

In another embodiment, a set of computer-useable instructions providing a method for generating emergency plans for a facility is illustrated. The method includes receiving an alert that includes an alert type. The alert type is identified. A plurality of emergency plans that are associated with the alert type are provided. A location distribution status is received. Based on the location distribution status, an emergency plan is generated. The emergency plan is then displayed to a user.

In yet another embodiment, a graphical user interface (GUI) stored on one or more computer-storage media and executable by a computing device is provided. The GUI comprises an emergency plan identification area that identifies at least one emergency plan for a designated area of a facility. A blueprint area that displays a blueprint of the facility including the designated area is provided. An alert source indicator that identifies a source of an alert is provided. A special instructions area that displays special instructions that apply to the designated area is provided. A route area that displays textual instructions of an emergency plan for the designated area is provided. An identification area that displays at least one subject associated with the designated area is also provided.

Additional objects, advantages, and novel features of the invention will be set forth in part in the description which follows, and in part will become apparent to those skilled in the art upon examination of the following, or may be learned by practice of the invention.

### BRIEF DESCRIPTION OF THE DRAWING

The present invention is described in detail below with reference to the attached drawing figures, wherein:

FIG. 1 is a block diagram of an exemplary computing environment suitable for use in implementing the present invention;

FIG. 2 is a flow diagram illustrating a first exemplary method for generating emergency plans for a facility, in accordance with an embodiment of the present invention;

FIG. 3 is a flow diagram illustrating a second exemplary method for generating emergency plans for a facility, in accordance with an embodiment of the present invention;

FIG. 4 is an exemplary graphical user interface in accordance with embodiments of the present invention; and

FIG. 5 is a schematic diagram of an exemplary network operating environment suitable for use in implementing embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

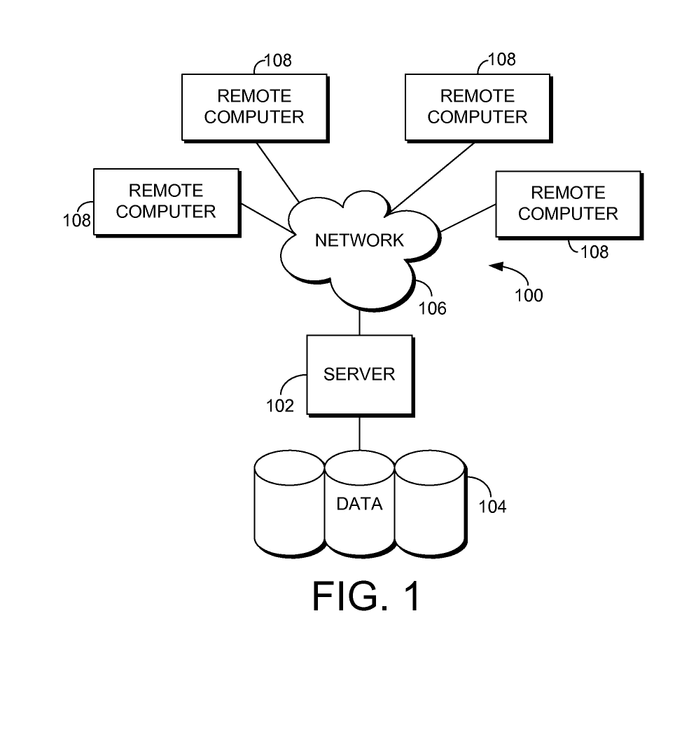

Referring to the drawings in general, and initially to FIG. 1 in particular, an exemplary computing system environment on which embodiments of the present invention may be implemented is illustrated and designated generally as reference numeral 10. It will be understood and appreciated by those of ordinary skill in the art that the illustrated computing system environment 10 is merely an example of one suitable computing environment and is not intended to suggest any limitation as to the scope of use or functionality of the invention. Neither should the computing system environment 10 be interpreted as having any dependency or requirement relating to any single component or combination of components illustrated therein.

Embodiments of the present invention may be operational with numerous other general purpose or special purpose computing system environments or configurations. Examples of well-known computing systems, environments, and/or configurations that may be suitable for use with embodiments of the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary computing system environment 10 includes a general purpose computing device in the form of a control server 12. Components of the control server 12 may include, without limitation, a processing unit, internal system memory, and a suitable system bus for coupling various system components, including database cluster 14, with the server 12. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 12 typically includes, or has access to, a variety of computer readable media, for instance, database cluster 14. Computer readable media can be any available media that may be accessed by server 12, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 12. Communication media typically embodies computer readable instructions, data structures, program modules, or other data in a modulated data signal, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 14, provide storage of computer readable instructions, data structures, program modules, and other data for the server 12.

The server 12 may operate in a computer network 16 using logical connections to one or more remote computers 18. Remote computers 18 may be located at a variety of locations, for example, but not limited to, clinical laboratories, hospitals and other inpatient settings, veterinary environments, ambulatory settings, medical billing and financial offices, hospital administration settings, home health care environments, clinicians' offices, schools, administrative offices, and the like. The remote computers 18 may be personal computers, servers, routers, network PCs, peer devices, other common network nodes, or the like, and may include some or all of the components described above in relation to the server 12. The devices can be personal digital assistants or other like devices.

Exemplary computer networks 16 may include, without limitation, local area networks (LANs) and/or wide area networks (WANs). Such networking environments are commonplace in offices, enterprise-wide computer networks, intranets, and the Internet. When utilized in a WAN networking environment, the server 12 may include a modem or other means for establishing communications over the WAN, such as the Internet. In a networked environment, program modules or portions thereof may be stored in the server 12, in the database cluster 14, or on any of the remote computers 18. For example, and not by way of limitation, various application programs may reside on the memory associated with any one or more of the remote computers 18. It will be appreciated by those of ordinary skill in the art that the network connections shown are exemplary and other means of establishing a communications link between the computers (e.g., server 12 and remote computers 18) may be utilized.

In operation, a user may enter commands and information into the server 12 or convey the commands and information to the server 12 via one or more of the remote computers 18 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 12. In addition to a monitor, the server 12 and/or remote computers 18 may include other peripheral output devices, such as speakers and a printer.

Although many other internal components of the server 12 and the remote computers 18 are not shown, those of ordinary skill in the art will appreciate that such components and their interconnection are well known. Accordingly, additional details concerning the internal construction of the server 12 and the remote computers 18 are not further disclosed herein.

Although methods and systems of embodiments of the present invention are described as being implemented in a WINDOWS operating system, operating in conjunction with an Internet-based system, one of ordinary skill in the art will recognize that the described methods and systems can be implemented in any system supporting the receipt and processing of healthcare orders. As contemplated by the language above, the methods and systems of embodiments of the present invention may also be implemented on a stand-alone desktop, personal computer, or any other computing device used in a healthcare environment or any of a number of other locations.

As previously mentioned, the present invention is related to generating emergency plans for a facility. More particularly, the present invention is related to generating emergency plans for a designated area with a facility for a specific alert type based on real-time data.

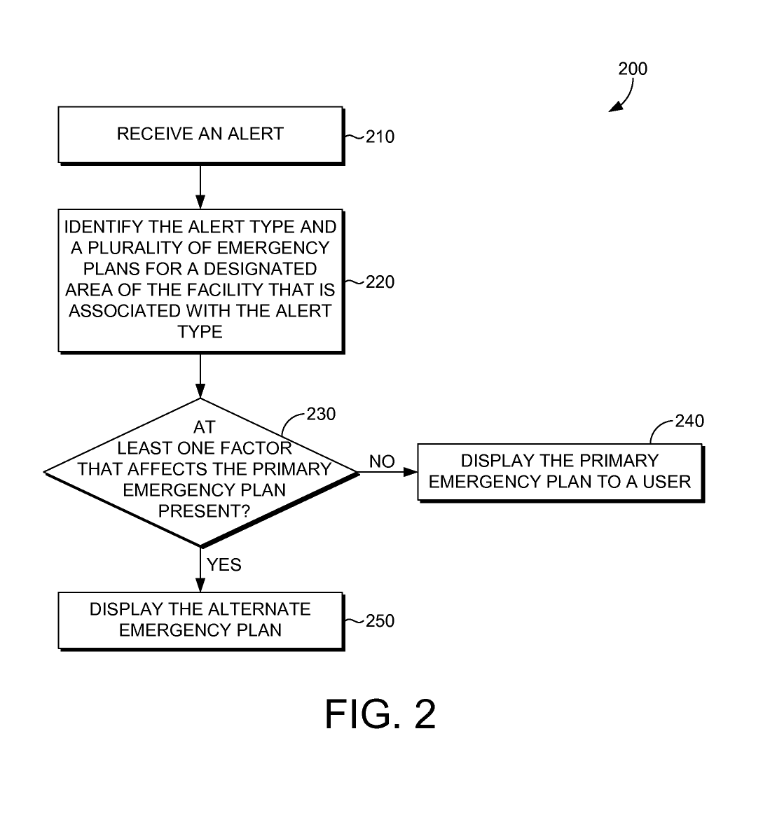

Turning now to FIG. 2, an illustrative flow diagram 200 is shown of a method for generating emergency plans for a facility by executing steps performed by a computer processor or instructions embodied on a computer-storage medium. An emergency plan, as used herein, refers generally to an organized plan to move objects into or out of a facility or a designated area therein. The emergency plans discussed herein may be applicable to any physical facility that may require an emergency plan including, but not limited to, hospitals, schools, nursing home facilities, office buildings, or the like. Objects, as used herein, include, but are not limited to, students, patients, personnel, equipment, administration, or the like.

Initially, an alert is received at block 210. An alert may be received in various forms. For example, an alert may be received as a manual alert, an automatic alert, or a system-generated alert. A manual alert refers to an alert that is manually indicated in an emergency management system. For instance, a school administer may manually input an alert in order to run an emergency drill or an alert source (e.g., a fire) may be witnessed by an individual and the individual may manually generate an alert as a result.

An automatic alert refers generally to an alert that is automatically generated based on preconfigured settings of the alert. For example, the emergency management system may be configured such that a specific alert is generated on a recurring schedule (e.g., quarterly). The recurring schedule may be on a specific date such as the first Monday of every quarter or may be random so that the automatic alert is triggered at some point during the quarter, but not at the same point every quarter. For example, a school administer may desire to perform routine fire evacuation drills but does not want participants to be aware of when the drills will occur. Thus, the school administer may set up a random automatic alert such that the school participates in a fire evacuation drill once per quarter on random days and the participants are unaware of a preset time for the drill. A further example may be the National Weather Service issuing a tornado warning for an area. The emergency management system may, as a result, generate a tornado alert and an emergency plan associated therewith.

A system-generated alert refers to an alert that is originally generated from a third party system other than the emergency management system (i.e., the alert is not manually input into the emergency management system or automatically generated from the emergency management system's configurations). For instance, a fire sensor system may detect a fire has originated within a facility and notify the emergency management system of a fire alert.

Irrespective of how the alert is generated and from what source it is received, the alert includes alert data that aids in the generation of an emergency plan for a facility. An alert may include an alert type indicator. An alert type indicator identifies the type of alert that has been generated including, but not limited to, a fire alert, a tornado alert, a bomb threat alert, a security breach, or the like. The alert type may be any type of alert that a user or third party system identifies. The alert type is important since it may determine the type of emergency plan that is generated for the facility. For example, an emergency plan associated with a fire alert will not use an elevator as part of the emergency plan. Thus, at block 220 an alert type is identified and a plurality of emergency plans associated with the alert type is generated.

The plurality of emergency plans associated with the alert type may be for a designated area of the facility. For instance, Room 1 of a facility may have a different emergency plan than Room 18 of the same facility. Each designated area of a facility has a unique set of emergency plans that are associated with the designated area. Once the unique set of emergency plans are generated for each designated area, each designated area receives emergency plans relevant to the designated area at, for example, a computing device within the designated area. Thus, a computing device in Classroom 1 will not receive (and display) an emergency plan that is specific to Classroom 18. The alert may be broadcast to each networked computing device within the facility. Emergency plans relevant to a designated area may be displayed on a computing device associated with that designated area. In embodiments, the emergency plans may also be displayed on a mobile device of a person associated with the designated area. Alternatively, persons determined to be in a particular area may receive emergency plans associated with the particular area.

The alert may also include an alert severity indicator. An alert severity, as used herein, generally refers to the severity of the alert. Exemplary indicators of an alert severity may designate the alert as a real alert or a drill alert. The alert severity may also be used to determine the type of emergency plan generated for the facility. For example, a drill alert may generate an emergency plan that needs to be tested and evaluated.

A special notes indicator may also be included in the alert. Special notes may be relevant to an entire facility, a designated area within the facility, an object within the facility, or the like. For instance, a special instruction for a designated area within a facility may be a task to perform at a designated safe location once the emergency plan is complete (e.g., verify a head count upon arriving at the designated safe location). Another example may concern an individual that requires special assistance during an emergency. A hospital facility may have multiple patients that require special assistance since many patients may be unable to exit alone for various reasons (e.g., physical disabilities that prohibit mobility of a patient, attached equipment that requires a patient to have assistance before moving, or the like). Additionally, schools may have students that have special needs and require assistance evacuating. In those situations, special notes may be associated with the designated area and/or the individual requiring assistance such that the emergency plan indicates that the individual requires assistance.

As previously mentioned, a plurality of emergency plans may be generated for a designated area of a facility. Thus, there may be more than one route available to evacuate the designated area. The plurality of emergency plans may include at least one primary emergency plan and one or more alternate emergency plans. A primary emergency plan refers generally to an emergency plan that, for one reason or another, is an ideal emergency plan or is preferred for a designated area. An alternate emergency plan refers generally to an emergency plan that is appropriate for the designated area when the primary emergency plan is not available.

Once the alert type and the plurality of emergency plans for the designated area have been identified, a determination whether at least one factor that affects the primary emergency plan is present is made at block 230. The primary emergency plan may be affected by various factors including, but not limited to, a location of objects within the facility, a blocked route, or the like.

A location of objects within the facility may be tracked using a plurality of sensors in the facility that receive signals from identifiers associated with the object. The sensors may be integrated into, for example, a Real-Time Locating System (RTLS). The RTLS may utilize any technology known in the art to track identifiers such as ultrasound technology, infrared (IR) technology, radio-frequency identification technology (RFID), wireless local area network, or the like. An exemplary sensor system is the Cricket Indoor Location System sponsored by the MIT Project Oxygen Partnership. Real-time locations of identifiers may be identified upon being detected by a sensor. Exemplary identifiers may include badges, tags, wristbands, or the like.

The real-time location of objects within the facility is useful in determining which emergency plan of the plurality of emergency plans associated with the alert type should be used. For instance, assume that Classroom 1 is associated with Emergency Plan 1 that anticipates that 25 students will use Emergency Plan 1. If the real-time location of students within the facility indicates that Classroom 1 currently has 50 students occupying the space, the actual number of students to use the emergency plan is double the anticipated number of students to use the emergency plan. As a result, the emergency plan may need to be adjusted based on the location of students within the facility. As such, the anticipated number of individuals to use the emergency plan may be identified, along with the actual number of individuals to use the plan, based on RTLS data. Upon determining that the actual number of individuals to use the emergency plan exceeds the anticipated number of individuals to use the emergency plan by a predetermined threshold, the plan may need to be adjusted or invalidated.

The real-time location of individuals within the facility may also be useful to adjust the emergency plan that is currently in progress. For example, the real-time location of individuals may be monitored to determine whether the individuals are completing the emergency plan within a predetermined amount of time. If individuals are not evacuating fast enough (i.e., within the predetermined amount of time), the emergency plan can be adjusted in an attempt to complete the emergency plan faster. Adjustments or updates to an emergency plan may be displayed in real-time such that all views of the emergency plan include the most up to date information.

Another factor that may affect the primary emergency plan may be a blocked route. A blocked route may be a trigger to an alert, for example, the location of a fire. The blocked route may be known to the system as a result of manually inputting the blocked route. The blocked route may also be known to the system as a result of a system-generated alert that identified the alert source (e.g., a fire system identifies that the temperature in the gymnasium is 250 degrees).

The emergency plan may need to be adjusted or invalidated due to the blocked route. For example, assume that Classroom 8 is associated with a primary emergency plan that exits students through a gymnasium exit. The fire system has identified that the gymnasium is 250 degrees and likely the source of the fire. The primary emergency plan is affected by the location of the alert source and will likely be invalidated as a blocked path. Another example of a blocked path, as explained earlier, would be an emergency plan for a fire that includes an elevator. Use of an elevator in a fire would be identified as a blocked route and the emergency plan would be invalidated. As previously set forth, updates or adjustments to the emergency plans may be displayed in real-time on all display devices such that each presentation includes the most up to date information.

Once a determination is made that factors that affect the primary emergency plan are not present, the primary emergency plan is displayed to a user at block 240. If a determination is made that factors that affect the primary emergency plan are present, an alternate emergency plan is displayed to the user at block 250. The emergency plan may be displayed, for example, on a computing device within the designated area of the facility, on a portable computing device, or the like. The display devices may be networked together and each may include instructions for the emergency management system such that the emergency management system is aware of the location of each computing device and may display the relevant emergency plan to each respective device. In embodiments, the emergency plans may be displayed on a mobile device of a user that is associated with the designated area. Alternatively, a mobile device that is determined to be within the designated area may also receive emergency plans for the designated area.

In alternate embodiments, the emergency management system may be aware of a particular user that is logged into a computing device that is not being tracked via RTLS. A location of the user may be identified and, thus, the user's location may be associated with a location of the computing device.

In further embodiments, the alternate emergency plan is identified and it is determined whether any factors that affect the alternate emergency plan are present. Upon determining that no factors are present that affect the alternate emergency plan, the alternate emergency plan is displayed to the user. Upon determining that factors are present that affect the alternate emergency plan, a second alternate emergency plan is identified. The process may continue until an emergency plan containing no factors that affect that emergency plan is identified.

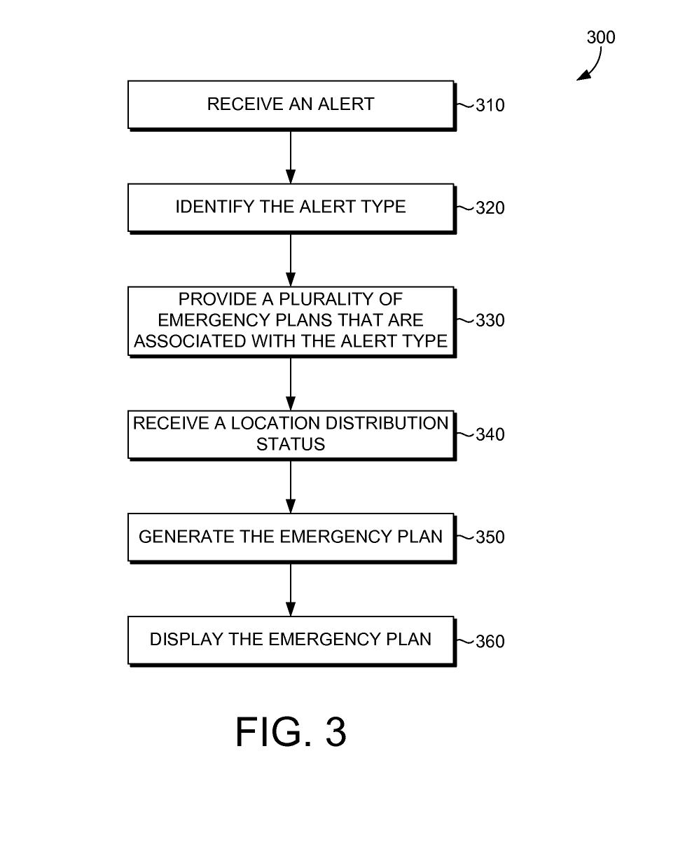

Turning now to FIG. 3, an illustrative flow diagram 300 is shown of a method for generating emergency plans for a facility by executing steps performed by a computer processor or instructions embodied on a computer-storage medium. Initially, an alert is received at block 310. The alert may be received as a manual alert, a system-generated alert, or an automatic alert. The alert may include an alert type indicator, an alert severity indicator, a special notes indicator, or the like.

Once the alert is received, the alert type is identified at block 320. The alert severity and special notes may also be identified. Based on the alert type, a plurality of emergency plans that are associated with the alert type are provided at block 330. The plurality of emergency plans may include a primary emergency plan and an alternate emergency plan.

At block 340 a location distribution status is received. A location distribution status refers generally to a distribution of a population of objects within a facility. A location of objects or items within the facility may be tracked using a plurality of sensors in the facility that receive signals from identifiers associated with the object. The sensors may be integrated into, for example, a RTLS. The RTLS may utilize any technology known in the art to track identifiers such as ultrasound technology, IR technology, RFID, wireless local area network, or the like. Real-time locations of identifiers may be identified upon being detected by a sensor. Exemplary identifiers may include badges, tags, wristbands, or the like.

The location distribution status allows a user and/or the emergency management system to identify objects within the facility and the location of the objects within the facility. The location distribution status may be received continuously from the RTLS and stored in a database to be used throughout the generation of an emergency plan.

The emergency management system can easily identify if an actual use of an emergency plan will exceed an anticipated use of the emergency plan and determine if the emergency plan may be adjusted to accommodate the location distribution or if a new emergency plan is required. The real-time location may also be used to identify congested areas in an emergency such that the emergency plan may be adjusted and the congestion may be evaluated to determine if the emergency plan is effective.

The location distribution status not only indicates a real-time location but it may also identify a specific status of the object. For example, an object that is still within the facility but near to and proceeding to an exit may be associated with a low caution indicator. An object may be associated with a high caution indicator when the object is near the alert source, far from an exit, or the like. Further, if an object is identified as not proceeding toward an exit, a stationary indicator may be associated with the object. In embodiments, an object that has safely completed the emergency plan may not be displayed at all or, alternatively, may be displayed along with a safe indicator that identifies the object as reaching safety.

Another specific status that may be identified in the location distribution status is a special notes status. A special notes indicator may be associated with an object that is subject to special instructions. For instance, a handicapped student or an ill patient may require assistance evacuating a facility and may be associated with special instructions. Additionally, a floor coordinator may be responsible for performing a head count once the floor coordinator has exited the facility. In that case, the special notes indicator may be associated with the floor coordinator or a designated area under the floor coordinator's control.

Based on the location distribution status, an emergency plan is generated at block 350 and displayed at block 360. The emergency plan may be displayed as a broadcast alert in the facility via networked computing devices. The computing devices may be configured with emergency management system instructions such that the system is aware that the computing device is in a specific location. The emergency plan may also be displayed via a portable computing device such as a mobile phone. A location of the portable device may be ascertained using a tracking identifier of the portable device, a tracking identifier of an individual associated with the portable device, or the like.

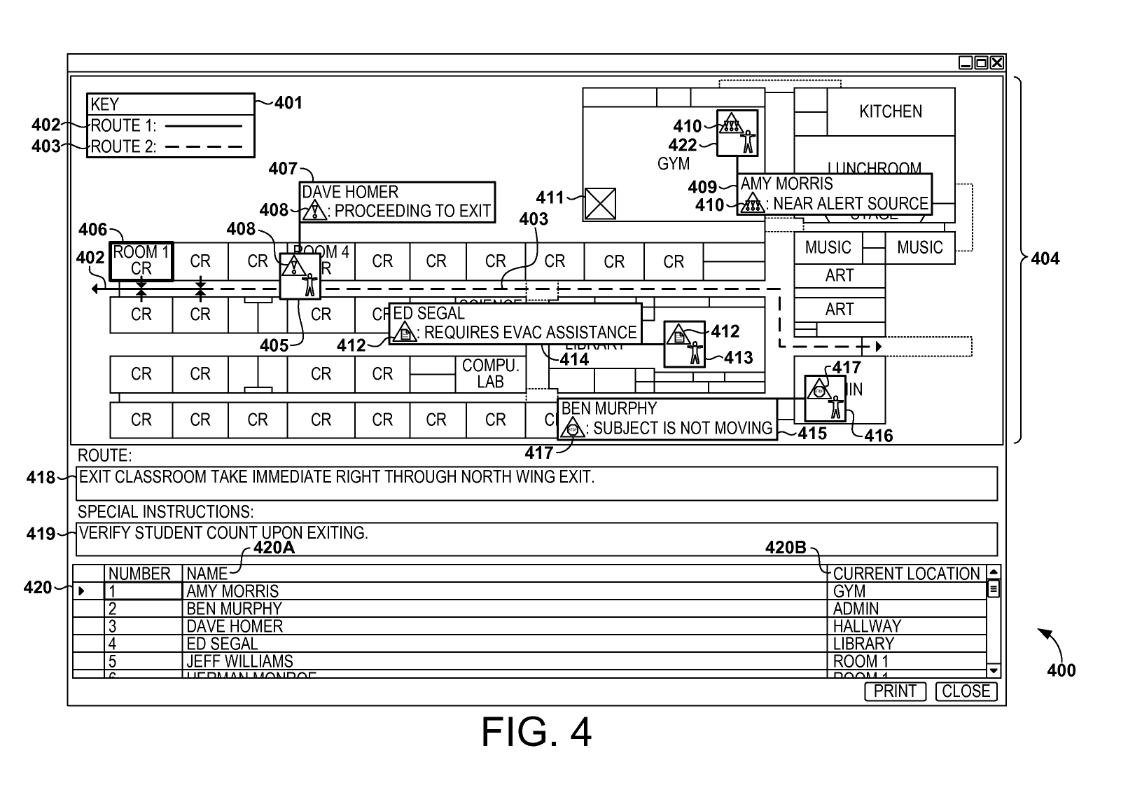

Turning now to FIG. 4, an illustrative graphical user interface (GUI) 400 is shown for an emergency plan, in accordance with an embodiment of the present invention. The GUI includes an emergency plan identification area 401 that identifies at least one emergency plan for a designated area of a facility. Emergency plan identification area 401 illustrates that a primary emergency plan 402 and an alternate emergency plan 403 have been generated.

GUI 400 also includes a blueprint area 404 of a facility that displays a blueprint of the facility and includes a designated area 406. Blueprint area 404 may highlight a designated area. For example, designated area 406 is outlined darker than other areas of the facility. Blueprint area 404 may also include a location distribution status of each object within blueprint area 404 that has been associated with a location status. A location of objects within the facility may be tracked using a plurality of sensors in the facility that receive signals from identifiers associated with the individual or item. The sensors may be integrated into, for example, a RTLS. The RTLS may utilize any technology known in the art to track identifiers such as ultrasound technology, IR technology, RFID, or the like.

The RTLS generates signals that are communicated from the sensors to the identifiers to confirm a current location. The signals are received by the identifiers and the identifiers respond to the signals to confirm the current location. A response from an identifier is received by the sensors and the sensors are able to recognize and determine a real-time location of the responding identifier. The real-time location of the responding identifier and the object associated therewith is then displayed in blueprint area 404 of GUI 400. For instance, an object 405 is displayed in a hallway of blueprint area 404 while an object 422 is displayed in the gym of blueprint area 404.

Detailed information regarding the location status of each object may be displayed by selecting the object, hovering over the object, or the like. Once the object is indicated, a detail status window is displayed. Blueprint area 404 illustrates a low caution information window 407. Low caution information window 407 may be displayed by, among other things, hovering over object 405. Low caution information window 407 may also be displayed by hovering over a low caution indicator 408. Low caution information window 407 identifies object 405 as Dave Homer. The current location of object 405 may also be included as text within low caution information window 407. Low caution indicator 408 is displayed in low caution information window 407 along with a reason for identifying low caution indicator 408. In this case, low caution indicator 408 has been displayed because object 405 is proceeding to an exit but has not yet reached the exit.

Blueprint area 404 also includes a high caution information window 409. High caution information window 409 may be displayed upon selection of object 422 or a high caution indicator 410. High caution information window 409 identifies object 422 and may include a textual indication of a current location of object 422. High caution indicator 410 is displayed in high caution information window 409 along with a reason for identifying high caution indicator 410. In this case, high caution indicator has been displayed because object 422 is identified as being near an alert source.

An alert source may be indicated to emergency management system by manual input of the alert source (e.g., a user witnessed that a fire was in the gym and indicates the alert source in the manual alert) or by a system-generated alert (e.g., a fire system identifies that the temperature in the gym is 250 degrees and indicates the gym as the fire source). When the alert source is identified, blueprint area 404 displays an alert source indicator 411.

Blueprint area 404 may include a special notes information window 414. Special notes information window 414 may be displayed by, among other things, hovering over an object 413. Special notes information window 414 may also be displayed by hovering over a special notes indicator 412. Special notes information window 414 identifies object 413 as Ed Segal. The current location of object 413 may also be included as text within special notes information window 414. Special notes indicator 412 is displayed in special notes information window 414 along with a reason for identifying special notes indicator 412. In this case, special notes indicator 412 has been displayed because object 413 requires emergency assistance.

Blueprint area 404 may also include a stationary information window 415. Stationary information window 415 may be displayed by, among other things, hovering over an object 416. Stationary information window 415 may also be displayed by hovering over a stationary indicator 417. Stationary information window 415 identifies object 416 as Ben Murphy. The current location of object 416 may also be included as text within stationary information window 415. Stationary indicator 417 is displayed in stationary information window 415 along with a reason for identifying stationary indicator 417. In this case, stationary indicator 417 has been displayed because object 416 has been identified as stationary and may need assistance evacuating.

The indicators and information windows described above may be displayed according to user preference. Any indicator that is designated by a user to represent, for example, a low caution situation, may be used with emergency management system. Additionally, the windows described may be, for example, pop-up windows.

GUI 400 may further include a route area 418. Route area 418 may provide a textual description of the indicated route. For instance, blueprint area 404 indicates that primary emergency route 402 exits designated area 406 to take an immediate right to the exit. Route area 418 textually describes primary emergency route 402. Blueprint area 404 also illustrates alternate emergency route 403 for illustrative purposes only. Blueprint area 404 may not display alternate emergency route 403 if primary emergency route 402 is being used. Alternatively, blueprint area 404 may illustratively display alternate emergency route 403, as shown, even if primary emergency route 402 is being used.

GUI 400 may also include a special instructions area 419. Special instructions area 419 may display textual instructions that apply to a designated area, an object, a facility, or the like. For instance, special instructions area 419 indicates that a user in designated area 406 should verify a head count upon exiting. Special instructions area 419 may include any other note that a user should be informed of during an emergency. The notes in special instructions area 419 may apply to a designated area, a facility, a user, an object, or the like. Special instructions may be generated and/or updated in real-time. For example, if a student that is disabled is determined to be in the restroom at the moment an alert is generated, special instructions may be displayed that indicate a real-time need for assistance. Also, since the special instructions are real-time, once the special instructions are completed they may be removed from the display. Alternatively, when new special instructions are determined to be required, the display is updated to include the newly generated special instructions.

Objects of the facility may be displayed in identification area 420. The objects in identification area 420 may be associated with designated area 406 or a specific user. Identification area 420 may include a name area 420A that gives the names of the individuals and location area 420B that gives a current location associated with each individual. For example, Amy Morris is identified in location area 420B as being located in the gym and blueprint area 404 also indicates that Amy Morris is currently in the gym based on RTLS information. Objects in identification area 420 may also be associated with a home location that identifies a primary location associated with the object.

In alternative embodiments, emergency responders may be able to view the emergency plans. The emergency responders may be equipped with computing devices that are configured with the emergency management system such that the responders can view what the users in the facility are viewing. Alternatively, the responders may view a different display of the emergency plan that provides information relevant to their responsibilities. For example, the responders' computing device may display an entrance that should be used, a number of objects remaining in the facility, a number of objects requiring assistance, or the like. The display may also include a reverse emergency plan that provides the fastest, most efficient entrance to get to the emergency situation.

The computing device of the responders may work in association with the computing devices of the facility. For example, the computing device of the responders may indicate a special door to enter the facility during the emergency situation. In turn, the computing devices of the facility may display a special instruction that the entrance door needs to be unlocked for the responders.

Further embodiments of the present invention may involve using results of the alerts to generate the most efficient emergency plans based on the data collected. For instance, alert drills may be evaluated to identify problems with emergency plans. The results may be used for future developments of emergency plans.

Users may also review collected data to monitor their performance during alerts. For instance, a user may evaluate performance during last quarter with performance during this quarter to identify problem areas that need to be addressed. Multiple facilities may also combine their data to evaluate their performance against other facilities.

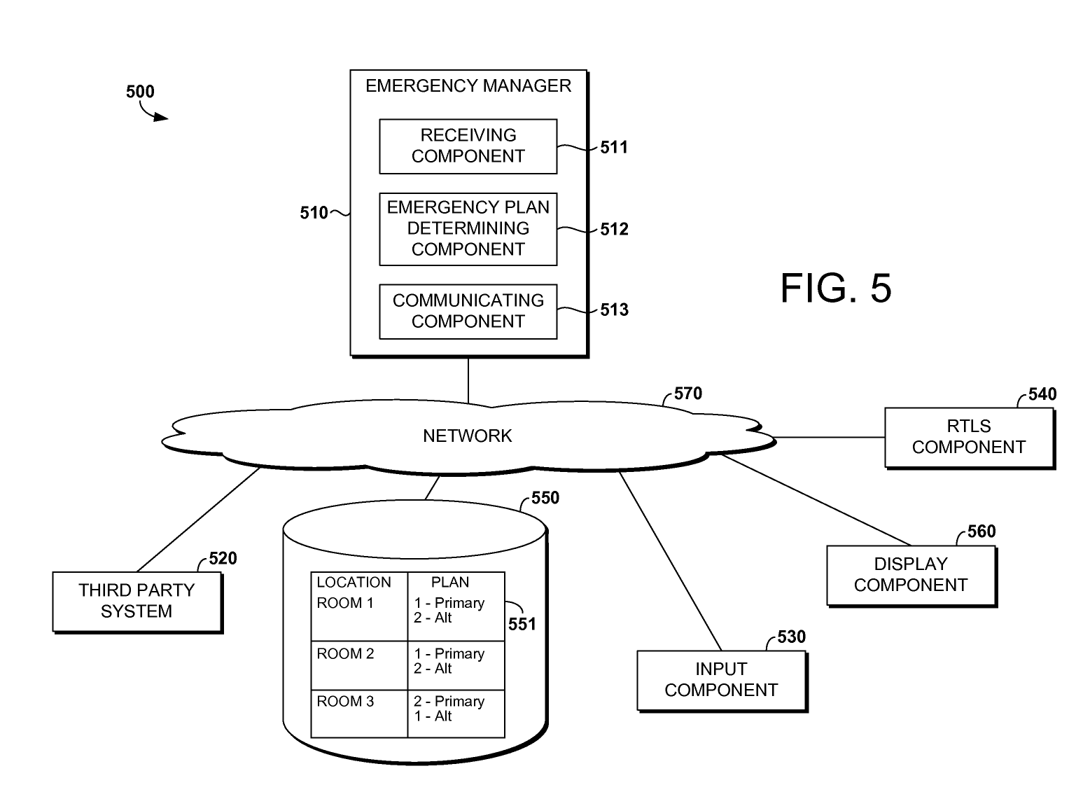

Turning now to FIG. 5, a schematic diagram of an exemplary network operating environment suitable for use in implementing embodiments of the present invention is illustrated. A system 500 may include an emergency manager 510, a third party system 520, an input component 530, a RTLS component 540, a database 550, and a display component 560, all in communication with one another through a network 570. Network 570 may be wired, wireless, or both, and include, without limitation, one or more wide area networks (WANs), one or more local area networks (LANs), one or more public networks, such as the Internet, and/or one or more private networks. Such networking environments are commonplace in offices, enterprise-wide computer networks, intranets and the Internet. Accordingly, network 570 is not further described herein.

Emergency manager 510 may be any device capable of managing emergency plans for a facility. Accordingly, emergency manager 510 may take on a variety of forms, such as a personal computer (PC), a laptop computer, a mobile phone, a personal digital assistant (PDA), a server, or any other device that is capable of managing emergency plans. In one embodiment, emergency manager 510 may be a computing device such as computing device 100 of FIG. 1.

Emergency manager 510 includes a receiving component 511, an emergency plan determining component 512, and a communicating component 513. Receiving component 511 receives alerts, as described above, as manual alerts, automatic alerts, or system-generated alerts. Receiving component 511 receives system-generated alerts from a third party system 520. Additionally, receiving component 511 receives other alerts from an input component 530. A user may manually input an alert into input component 530 that is communicated via network 560 to emergency manager 510. In embodiments, receiving component 511 may also receive location distribution status information from RTLS component 540, including any form of RTLS technology capable of providing location distribution status to emergency manager 510.

Upon receiving the alert, emergency plan determining component 512 determines, based on, for example, the alert type, a plurality of emergency plans for a designated area of a facility. Emergency plan determining component 512 may also determine whether at least one factor that affects the primary emergency plan is present. Location distribution status information may also be used to determine a plurality of emergency plans for the designated area.

Emergency manager 510 may utilize database 550 to identify and determine the plurality of emergency plans for a designated area. Database 550 includes sets of emergency plans that are associated with each alert type. Thus, an alert type may be identified and database 550 may be queried to retrieve the emergency plans associated with the specific alert type. Database 550 may also include emergency plans for a specific alert type that are associated with a designated area.

An emergency record 551 is illustrated as being stored in database 550. Emergency record 551 includes a plurality of emergency plans for each designated location with a facility. For example, emergency record 551 illustrates that Room 1 is associated with a Plan 1 as the primary emergency plan and Plan 2 as the alternate emergency plan.

Communicating component 513 communicates the emergency plans to a display component 560. Display component 560 may be any device that is capable of displaying an emergency plan. Accordingly, display component 560 may take on a variety of forms, such as a personal computer (PC), a laptop computer, a mobile phone, a personal digital assistant (PDA), a server, a television, or any other device that is capable of displaying an emergency plan. In embodiments, display component 560 may display emergency plans for the designated area that is associated with display component 560. Alternatively, display component 560 may be a device of a user associated with the designated area or determined to be in the designated area.

Those skilled in the art will appreciate that the present invention contemplates the presence of additional components and/or subcomponents of the illustrated system 500, and the components and/or subcomponents may be combined with one another and/or separated into new components and subcomponents.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the system and method. It will be understood that certain features and subcombinations are of utility and may be employed without reference to other features and subcombinations. This is contemplated by and is within the scope of the claims.

Having thus described the invention, what is claimed is:

1. One or more computer-storage media having computer-executable instructions embodied thereon that, when executed, perform a method for generating emergency plans for a facility, the method comprising:
receiving an alert, wherein the alert includes an alert type;
identifying the alert type and a plurality of emergency plans for a designated area of the facility that are associated with the alert type, wherein the plurality of emergency plans associated with the alert type includes a primary emergency plan and an alternate emergency plan;
determining whether at least one factor is present that affects the primary emergency plan;
based upon a determination that at least one factor that affects the primary emergency plan is not present, displaying the primary emergency plan to a user; and
based upon a determination that at least one factor that affects the primary emergency plan is present, displaying the alternate emergency plan to the user.

2. The computer-storage media of claim 1, wherein the alert is one of a manual alert, an automatic alert, or a system generated alert.

3. The computer-storage media of claim 1, wherein the alert further includes an alert severity and an indication of special instructions.

4. The computer-storage media of claim 1, wherein a factor that affects the primary emergency plan is a blocked path.

5. The computer-storage media of claim 1, wherein the alert type includes a fire alert, a tornado alert, or a security breach.

6. The computer-storage media of claim 1, further comprising:
based upon a determination that at least one factor is present that affects the primary emergency plan, invalidating the primary emergency plan.

7. The computer-storage media of claim 1, further comprising:
receiving a location distribution status from a real-time locating system.

8. One or more computer-storage media having computer-executable instructions embodied thereon that, when executed, perform a method for generating emergency plans for a facility, the method comprising:
receiving an alert, wherein the alert includes an alert type;
identifying the alert type;
providing a plurality of emergency plans that are associated with the alert type;
receiving a location distribution status, wherein the location distribution status is obtained from a real-time locating system;
based on the location distribution status, generating an emergency plan; and
displaying the emergency plan to a user.

9. The computer-storage media of claim 8, wherein the alert type includes a fire alert, a tornado alert, or a security breach.

10. The computer-storage media of claim 8, wherein the alert further includes an alert severity and an indication of special instructions.

11. The computer-storage media of claim 8, wherein the alert is one of a manual alert, an automatic alert, or a system generated alert.

12. The computer-storage media of claim 8, wherein the real-time locating system utilizes at least one of ultrasound technology, infrared technology, or radio-frequency identification technology.

13. The computer-storage media of claim 8, further comprising:
receiving an indication of a blocked path within the emergency plan;
invalidating the emergency plan; and
displaying an alternate emergency plan.

14. A graphical user interface (GUI) stored on one or more computer-storage media and executable by a computing device, said GUI comprising:
an emergency plan identification area that identifies at least one emergency plan for a designated area of a facility;
a blueprint area that displays a blueprint of the facility including the designated area;
an alert source indicator that identifies a source of an alert;
a special instructions area that displays special instructions that apply to the designated area;
a route area that displays textual instructions of an emergency plan for the designated area; and
an identification area that displays at least one object associated with the designated area.

15. The GUI of claim 14, wherein the special instructions area further displays special instructions that apply to an object within the designated area.

16. The GUI of claim 14, wherein the special instructions area further displays special instructions that apply to the designated area.

17. The GUI of claim 14, further comprising a location status indicator.

18. The GUI of claim 17, wherein hovering over the location status indicator displays a detail status window.

19. The GUI of claim 14, wherein the identification area further includes a location associated with the at least one object.

20. The GUI of claim 19, wherein the location associated with the at least one object includes a current location and a home location.
